(19) United States
(12) Patent Application Publication
(10) Pub. No.: US 2004/0254661 A1
(43) Pub. Date: Dec. 16, 2004

(54) Wireless sound apparatus having a MP3 encoder/decoder/recorder IC unit

(75) Inventors: Hon-Wai Ng, Hsinchu Hsien (TW); Li-Pai Chen, Taipei City (TW); Hsiang-Hsiung Yu, Hsinchu Hsien (TW)

Correspondence Address: BACON & THOMAS, PLLC, 625 SLATERS LANE, FOURTH FLOOR, ALEXANDRIA, VA, 22314

(73) Assignees: Phison Electronics Corp., Hsinchu Hsien (TW); A-DATA Technology Co., Ltd., Chung Ho City (TW)

(21) Appl. No.: 10/459,582

(22) Filed: Jun. 12, 2003

(51) Int. Cl. G06F 17/00

(52) U.S. Cl. 700/94

(57) ABSTRACT

A wireless sound apparatus capable of picking up the MP3 formatted file transmitted by a wireless information product and then the MP3 formatted file is encoded/decoded by the MP3 encoder/decoder/recorder IC unit into an analog signal that can be output by the speaker or MP3 formatted data can be recorded for storing into the wireless sound apparatus. Thus there is no need for the user to carry MP3 player or portable ROM/PDA for listening to music. Thus, by using the wireless sound apparatus of the present invention, the user is able to enjoy the music without any limitation.

### BACKGROUND OF THE INVENTION

1. The field of the Invention

The present invention relates to a wireless sound apparatus, and more particularly relates to a wireless sound apparatus having a MP3 encoder/decoder/recorder IC unit that is capable of picking up MP3 formatted data file transmitted by a information product for recording and/or playing the music. The wireless sound apparatus may be a wireless earphone or a wireless microphone.

2. Description of the Related Art

The technology of MP3 sound compression is increasingly well developed, and such technology can compress a commonly uncompressed musical data to tune of 1:12 or even more, and the distortion in the sound quality of CD is yet unidentifiable by human ears. In general, MP3 has its own exclusive format that requires a computer to run the program for executing the MP3 music file. The most commonly used MP3 playing program is WinAMP. Presently, the newer popular product such as walkman MP3 are available for directly playing MP3 music and therefore no computers are required to run the MP3 formatted file. Accordingly, MP3 player provides convenience to the user but however the user must buy a MP3 player for enjoying this convenience.

Presently, portable ROM and PDA are also available on the market for retrieving and transmitting information including musical data wirelessly and thereby a user can listen to music using the portable ROM and PDA devices. Further, wireless earphone and microphone are also available on the market for listening and recording music wirelessly and thereby providing additional convenience to the users.

Referring to FIG. 1, shows a circuit layout of a conventional information product having a wireless sound device. The information product 10, for example, a portable ROM or a PDA, has a USB connector 110 or flash/memory card 120 for controlling the MP3 encoder/decoder/recorder IC unit 140 for encoding/decoding for example a musical signal, which could be controlled by a USB storage disk controller 130, and the musical signal is converted into an analog signal by the converting circuit 150 which is then transmitted to an amplifying circuit 160. Furthermore, the amplified musical signal is transmitted through a sound output socket 170 and a sound transmission cord 180 to a sound input socket 210 of the wireless transmitter and then the musical signal is output by a wireless module 220. Then a wireless transmission interface 230 of the wireless earphone 20 transmits the sound signal to an amplifying circuit 240, which is then finally transmitted to the speaker 250 for outputting the music.

According to the above description, the sound output socket 170 of the information product 10 such as portable ROM or PDA has to be connected to a wireless transmitter for processing signal transmission with the wireless earphone 20. However information device described above have the following defects:

First, the user has to purchase a MP3 player, or a portable ROM or PDA for playing the MP3 formatted music.

Secondly, the user has to use a MP3 player, a notebook computer, a PDA, a pocket PC or other information product, in order to listen to MP3 formatted music.

Thirdly, the MP3 playing software is required for installing into a notebook computer, a PDA, a packet PC or other information product for encoding/decoding, recording and playing MP3 formatted music.

Accordingly, it is highly desirable to further improve the conventional technology to overcome the above defects.

### SUMMARY OF THE INVENTION

Accordingly, in the view of the foregoing, the present inventor makes a detailed study of related art to evaluate and consider, and uses years of accumulated experience in this field, and through several experiments, to create a new wireless sound apparatus of the present invention. The present invention provides an innovated cost effective wireless sound apparatus having a MP3 encoder/decoder/recorder IC unit.

In accordance with the above object and other advantages of the present invention provides a wireless sound apparatus, wherein the wireless sound apparatus comprises a wireless transmission interface, a MP3 encoder/decoder, a recording IC and a speaker or speaker with a microphone.

According to an aspect of the present invention, the MP3 formatted signal that is transmitted by a wireless information product such as portable ROM or PDA is encoded/decoded by the built-in MP3 encoder/decoder/recorder IC unit for outputting music or recording the MP3 formatted signal in the wireless sound apparatus of the present invention. The wireless sound apparatus may be a wireless speaker or wireless speaker with a microphone.

According to one aspect of the present invention, the wireless sound apparatus capable of picking up the MP3 formatted file transmitted by a wireless information product and then the MP3 formatted file is encoded/decoded by the MP3 encoder/decoder/recorder IC unit into an analog signal that can be output by the speaker or MP3 formatted data can be recorded for storing into the wireless sound apparatus. Thus there is no need for the user to carry MP3 player or portable ROM/PDA for listening to music. Thus, by using the wireless sound apparatus of the present invention, the user is able to enjoy the music without any limitation.

According to another aspect of the present invention, in case of using a wireless microphone, the built in MP3 encoder/decoder/recorder IC unit of the wireless sound apparatus is capable of converting the analog signal received through the microphone into MP3 digital signal and then the MP3 digital signal is transmitted through the wireless transmission interface to a wireless information product such as portable ROM or PDA.

### BRIEF DESCRIPTION OF THE DRAWING

FIG. 1 illustrates a circuit layout of a conventional information product with a wireless sound device.

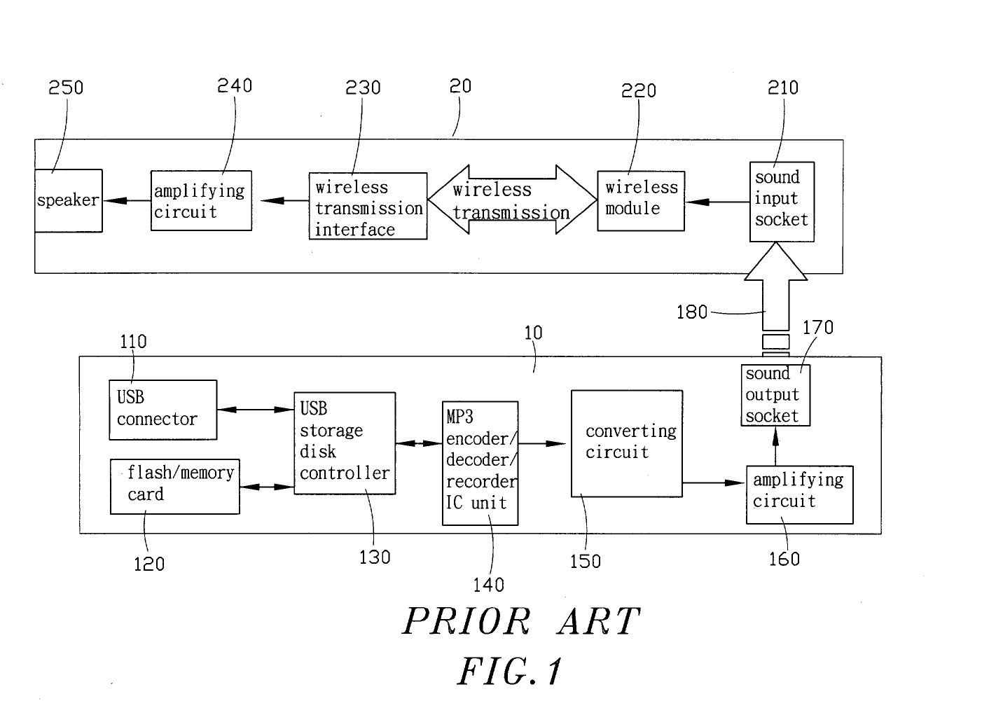

FIG. 2 illustrates a circuit layout of a wireless sound apparatus of the present invention.

FIG. 2A illustrates a power supply circuit layout of the wireless sound apparatus of the present invention.

FIG. 2B illustrates a circuit layout of a wireless transmission interface of the wireless sound apparatus of the present invention.

FIG. 2C illustrates a circuit layout of the MP3 encoder/decoder/recorder IC unit with a speaker of the wireless sound apparatus according to one preferred embodiment of the present invention.

FIG. 3 illustrates an operation process flowchart of the wireless sound apparatus according one preferred embodiment of the present invention.

FIG. 4 illustrates a circuit layout of the wireless sound apparatus according to another preferred embodiment of the present invention.

FIG. 5 illustrates an operation process flowchart of the wireless sound apparatus according another preferred embodiment of the present invention.

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

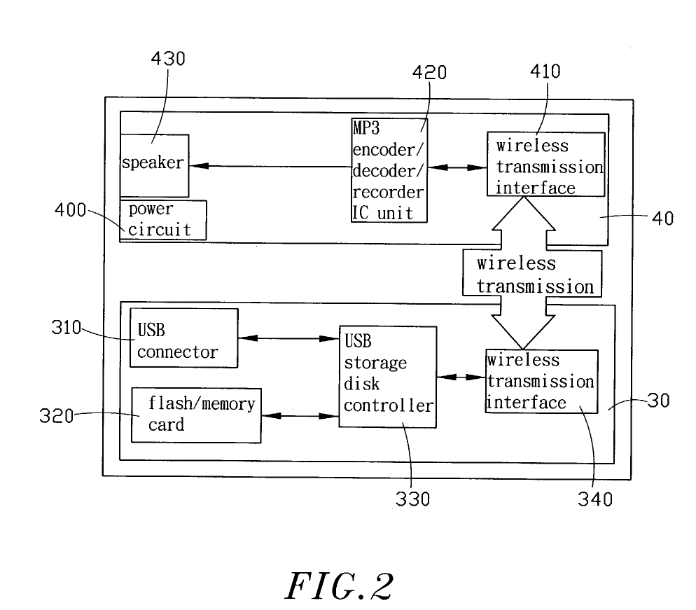

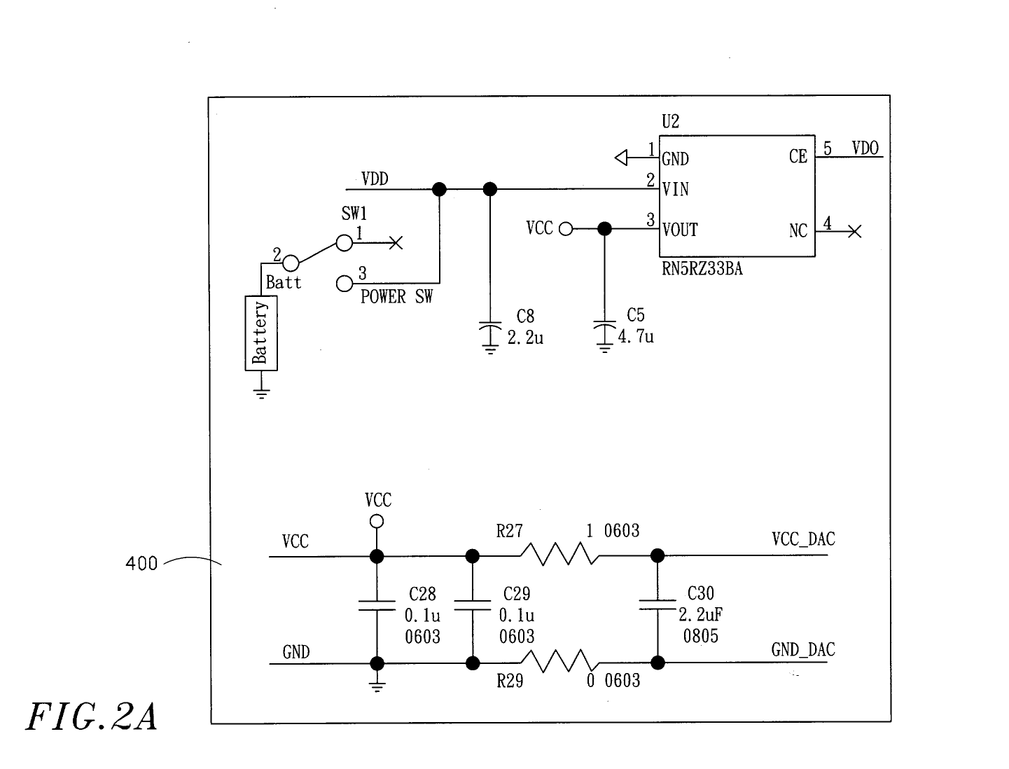

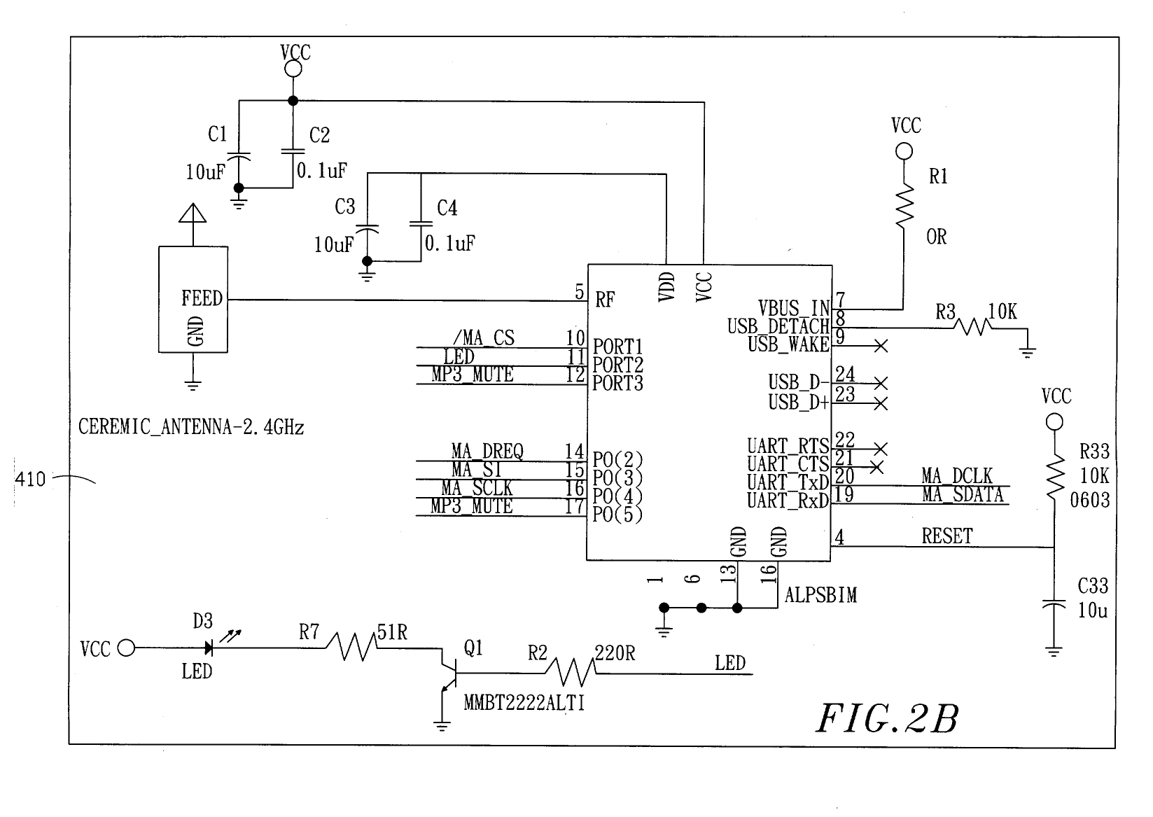

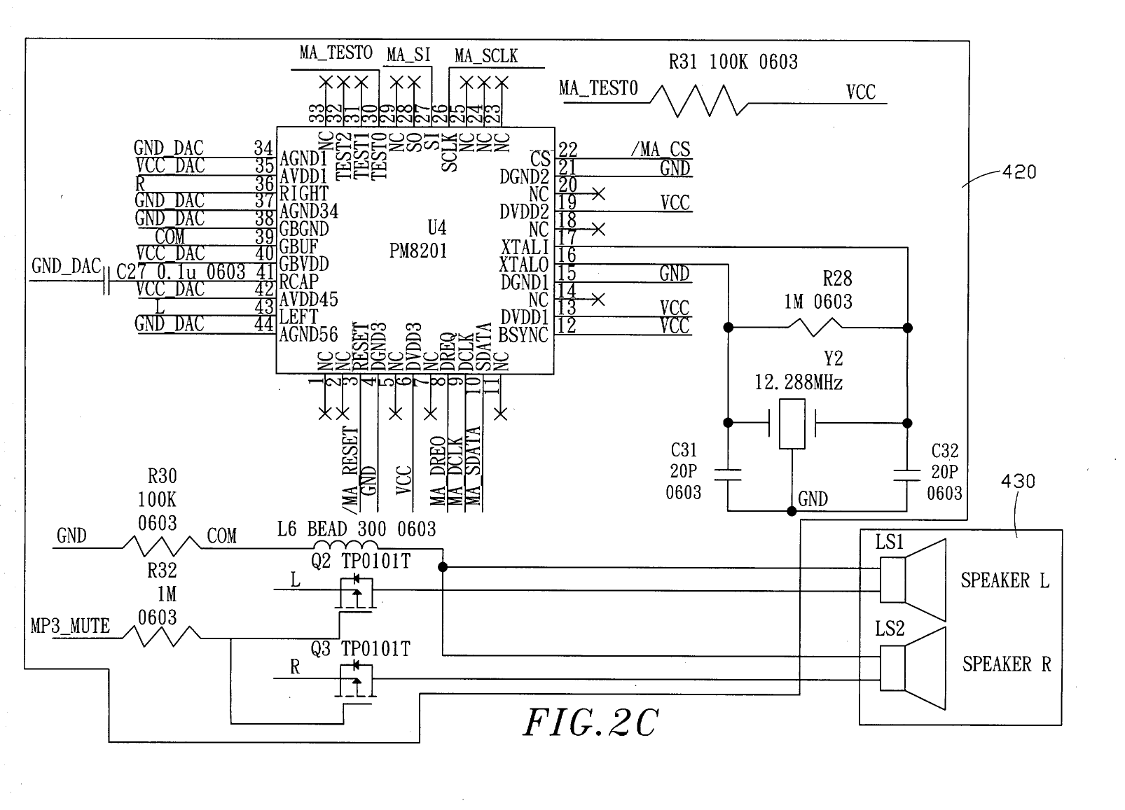

Referring to FIGS. 2, 2A, 2B and 2C, the wireless sound apparatus 40 comprises a wireless transmission interface 410, a MP3 encoder/decoder/recorder IC unit 420, a speaker 430 and a power circuit 400 for providing power to all circuit components. The wireless transmission interface 410 is for receiving and transmitting the MP3 formatted signal, and the MP3 encoder/decoder/recorder IC unit 420 is for converting a MP3 formatted signal into an analog signal or for converting an analog signal into a digital signal, and the speaker 430 is for outputting the analog signal in a form of sound.

After wireless transmission interface 410 of the wireless sound apparatus 40 receives the MP3 formatted signal from the wireless transmission interface 340 of the wireless information product 30 such as portable ROM or PDA, the MP3 encoder/decoder/recorder IC unit 420 decodes the MP3 formatted signal into an analog signal and then the analog signal is output through the speaker 430. A computer or other electronic device with a USB interface or a flash/memory card 320 can be connected to the wireless information product 30 such as portable ROM or PDA flash/memory card by using a USB connector 310 for retrieving the MP3 formatted data. An USB storage disk controller 330 of the wireless information product 30 can access and control the wireless transmission interface 340 to transmit the MP3 formatted data to the wireless sound apparatus 40.

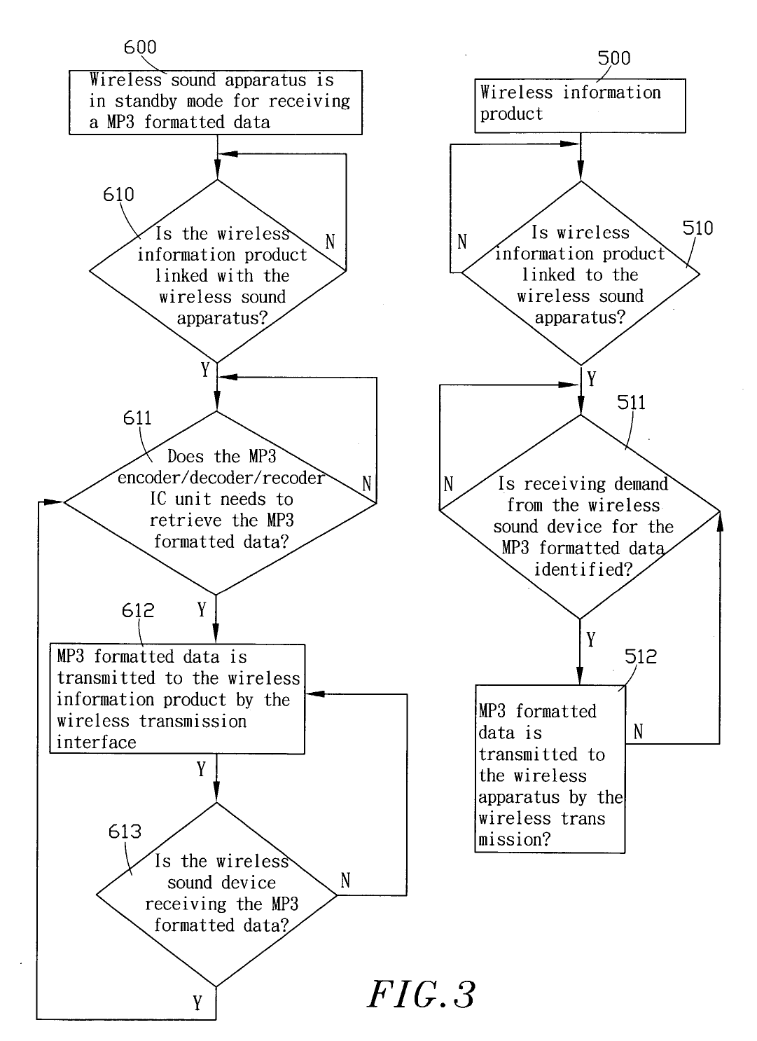

Referring to FIG. 3, the operation process of the wireless sound apparatus according to one preferred embodiment is described as follows. The operation process begins with step (500) in which the wireless information product 30 such as portable ROM or PDA is provided. Next, in step (510) whether or not wireless information product is linked to the wireless sound apparatus 40 is determined, if yes, then the process proceeds to step (511), if not, the process returns to step (510). In step (511) whether receiving demand from the wireless sound device 40 for the MP3 formatted data is identified, if yes, then the process proceeds to step (512), if not, the step (511) is repeated. In step (512) the MP3 formatted data is transmitted to the wireless sound apparatus 40 by the wireless transmission interface 340 and 410, if not, the process returns to step (511).

Further, in step (600) the wireless sound apparatus 40 is in standby mode for receiving a MP3 formatted data. Next, in step (610) whether the wireless information product 30 such as portable ROM or PDA is linked with the wireless sound apparatus 40 is determined, if yes, the process proceeds to step (611), if not, the step (610) is repeated. Next, in (611) whether the MP3 encoder/decoder/recorder IC unit 420 needs to retrieve the MP3 formatted data is determined, if yes, the process proceeds to step (612), if not, the step (611) is repeated. Next, in step (612) the MP3 formatted data is transmitted to the wireless information product 30 such as portable ROM or PDA by the wireless transmission interface 340 and 410, and then process proceeds to step (613). In step (613) whether the wireless sound device 40 is receiving the MP3 formatted data is determined, if yes, then the process proceeds to step (611), if not, the step (612) is repeated.

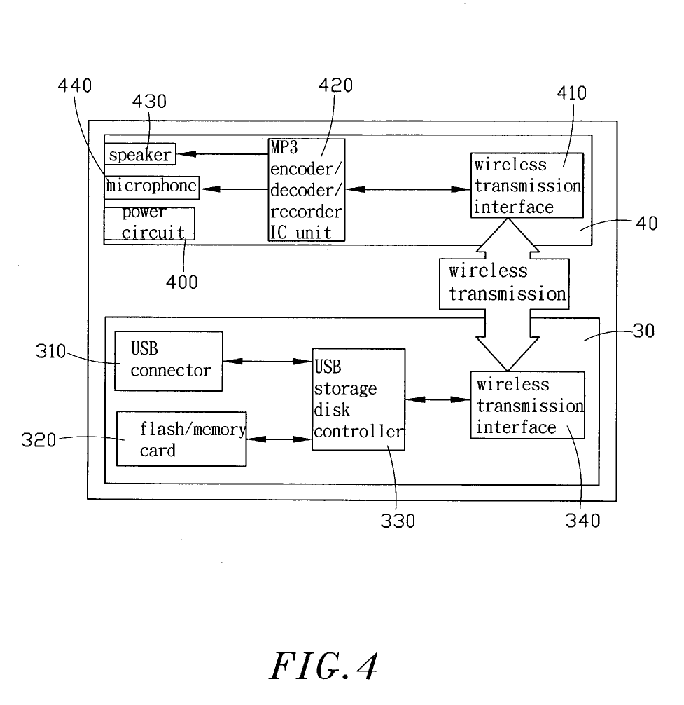

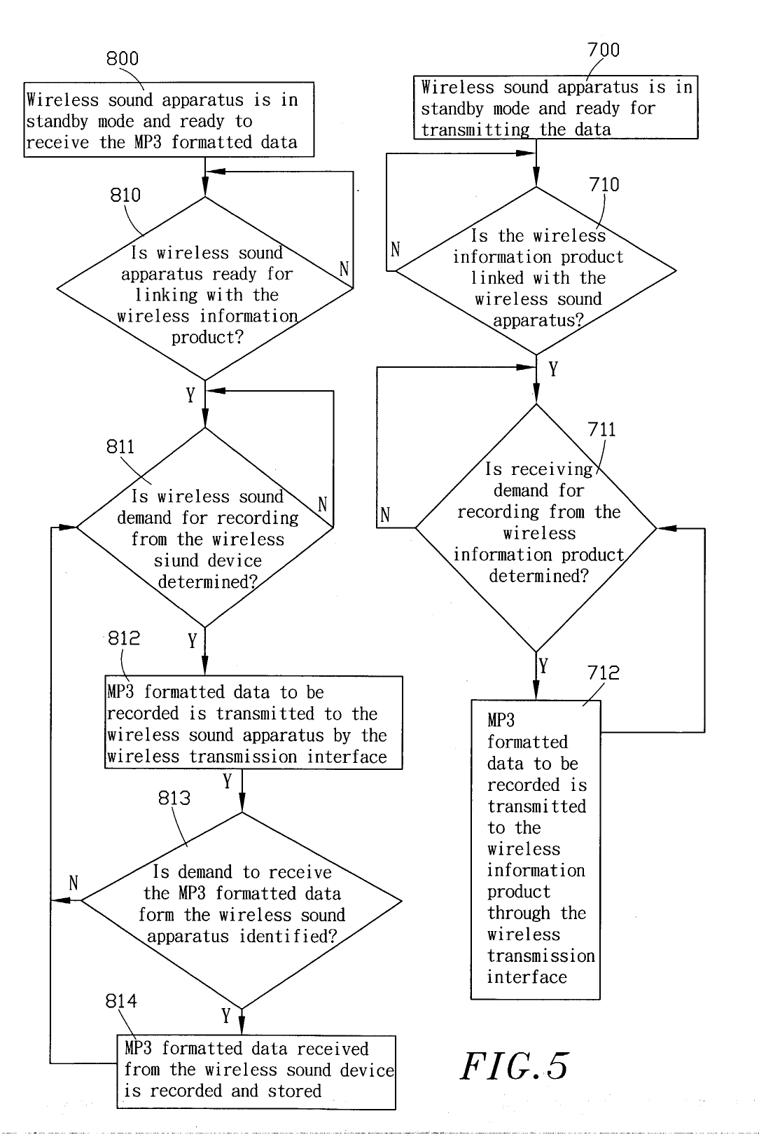

Referring to FIGS. 4 and 5, the MP3 encoder/decoder/recorder IC unit 420 of the wireless sound apparatus 40 is connected to a microphone 440. The sound data in a form of analog signal received by the microphone 440 is encoded into a MP3 formatted digital signal by the MP3 encoder/decoder/recorder IC unit 420, and then the wireless transmission interface 410 transmits the MP3 formatted digital signal to the wireless transmission interface 340 of the wireless information product 30 such as portable ROM or PDA. Further, the USB storage disk controller 330 controls the USB connector 310 to transmit the data to a computer or other electronic device with an USB adaptor interface.

Furthermore, the data can be stored into the flash/memory card 300 through the USB storage disk controller 330, and the operation process is described as follows. The process begins at step (700) in which the wireless sound apparatus 40 is in standby mode and ready for transmitting the data. Next, in step (710) whether the wireless information product 30 such as portable ROM or PDA is linked with the wireless sound apparatus 40 is determined, if yes, then the process proceeds to step (711), if not, the step (710) is repeated. In step (711) whether receiving demand for recording from the wireless information product 30 such as portable ROM or PDA is determined, if yes, the process proceeds to step (712), if not, the step (711) is repeated. In step (712) the MP3 formatted data to be recorded is transmitted to the wireless information product 30 such as portable ROM or PDA through the wireless transmission interface 340, if not, the process returns to step (711).

Additionally, the operation process of wireless information product 30 such as portable ROM or PDA receiving the MP3 formatted data transmitted by the wireless sound apparatus 40 is described as follows. The process begins at step (800) in which the wireless information product 30 such as portable ROM or PDA is in standby mode and ready to receive the MP3 formatted data. Next, in step (810) whether the wireless sound apparatus 40 is ready for linking with the wireless information product 30 is determined, if yes, the process proceeds to step (811), if not, the step (810) is repeated. In step (811) whether receiving demand for recording from the wireless sound device 40 is determined, if yes, the process proceeds to step (812), if not, the step (811) is repeated. In step (812) the MP3 formatted data to be recorded is transmitted to the wireless sound apparatus 40 by the wireless transmission interface 410. Next, in step (813) whether demand to receive the MP3 formatted data from the wireless sound apparatus 40 is determined, if yes, the process proceeds to step (814), if not, the step (811) is repeated. In step (814) the MP3 formatted data received from the wireless sound device 40 is recorded and stored and then process returns to step (811).

The wireless transmission interface 410 may be an infrared interface, a frequency carrier interface, a blue-tooth interface or any other equivalent interface having transmission functionality.

Additionally, the wireless transmission information product 30 may be a flash memory storage device (portable ROM), a PDA or any other equivalent product having MP3 playing and/or recording functionality.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

What the invention claimed is:

1. A wireless sound apparatus having a MP3 encoder/decoder/recorder IC unit capable of receiving a MP3 formatted data transmitted by a wireless transmission interface of a wireless information product, the wireless sound apparatus comprising:
a MP3 encoder/decoder/recorder IC unit for decoding said MP3 formatted data received from said wireless transmission interface;
a speaker for outputting said decoded MP3 formatted data; and
a power circuit for providing power to circuit components.

2. The wireless sound apparatus according to claim 1, wherein said MP3 encoder/decoder/recorder IC unit is connected to a microphone, and wherein after said microphone receives an analog signal, said analog signal is encoded into a MP3 formatted signal by said MP3 encoder/decoder/recorder IC unit, which is then transmitted to said wireless information product through said wireless transmission interface.

3. The wireless sound apparatus according to claim 1, wherein said wireless transmission interface is comprised of an infrared interface.

4. The wireless sound apparatus according to claim 1, wherein said wireless transmission interface is comprised of a frequency carrier interface.

5. The wireless sound apparatus according to claim 1, wherein said wireless transmission interface is comprised of a blue-tooth interface.
